(19) United States
(12) Patent Application Publication
(10) Pub. No.: US 2007/0100902 A1
(43) Pub. Date: May 3, 2007

(54) Two way incremental dynamic application data synchronization

(76) Inventors: Dinesh Sinha, North Brunswick, NJ (US); Tanushree Shrinivas Kharvandikar, Pune (IN)

Correspondence Address: Mr. Walter J. Tencza Jr., Suite 3, 10 Station Place, Metuchen, NJ, 08840, US

(21) Appl. No.: 11/260,063

(22) Filed: Oct. 27, 2005

(51) Int. Cl. G06F 17/30

(52) U.S. Cl. 707/201

(57) ABSTRACT

An apparatus is provided including an application data monitor, an application data sync engine, and a front end, each of which is typically implemented by computer software running on a computer. The apparatus may include a computer memory, and an application data log file data base including one or more application data log folders stored in the computer memory. Changes to source or image application data A can be monitored by the application data monitor.

### FIELD OF THE INVENTION

This invention relates to improved methods and apparatus concerning synchronization of computer data.

### BACKGROUND OF THE INVENTION

The computer software set in any computer is typically comprised of a plurality of application computer software programs running as part of an operating system and a plurality of application computer software programs that have been installed separately from the operating system. To function properly, each of these application computer programs typically reads or writes its own application data to its own application data base or file. Application data, application data bases, or application data files may be shared by two or more application computer software programs. Each application data base or file maintains a current state of a particular application computer software program. Each application computer software program also typically includes application executables and various libraries. The application executables and various libraries are typically static in nature. However, application data, such as in an application data base or file, typically changes frequently.

To preserve the dynamic state of each application computer software program, it would be necessary to duplicate the data in the corresponding application data base or file. The need for duplicating (backup or replication) is prioritized further if the application computer software program in question is a vital application computer software program. Backup of an application data base or file typically includes moving changes from a source file to a destination file. Synchronization typically includes two way movement of changes between a source file and a destination file. Some examples of application data stored in application data bases or files are database files, electronic mail (“e-mail”) client file or multi-media data.

Application data, application data bases of files, can grow to very large sizes and as the size or amount of application data increases, it becomes more and more difficult to either backup or synchronize the data. Besides most application computer software programs don't allow access to their own application data in their own application data bases or files. Also, changes are constantly happening to application data in application data bases or files. While replicating the application data, it is necessary to make sure that the replicated data is in a consistent state. Also, synchronization has its own set of issues specially relating to conflict where the same items are changed in a conflicting manner on both sides. Besides, sometimes the synchronization action in many cases would be very user dependent. For example, if a mail message is deleted from one side and modified on the other, some users might want the later change to be replicated, other would want the changes in the primary file to override the changes in the secondary files and others would want the delete action to be overridden. We can not go by the assumption that every user would want the same action for the same set of changes. Therefore, there is a need to make the action to be taken by the synchronization module to be configurable.

### SUMMARY OF THE INVENTION

The present invention in one or more embodiments provides an apparatus comprising an application data monitor, an application data sync engine, and a front end, each of which is typically implemented by computer software running on a computer. The apparatus may also be comprised of a computer memory, and an application data log file data base including one or more application data log folders stored in the computer memory.

In one embodiment, changes to source or image application data A can be monitored by the application data monitor. Changes to source or image application data A are stored in one or more application data log folders. A user can use the front end to select source application data A to be synchronized with image application data A. The application data sync engine synchronizes the source application data A with the image application data A by applying the changes made to the source application data A to the image application data A or by applying changes made to the image application data A to the source application data A.

The apparatus may be further comprised of a preferences data base stored in the computer memory. The preferences data base may store setting information required by the application data monitor, front end, and the application data sync engine.

In one embodiment, a method is provided comprising the steps of monitoring changes to source or image application data A, storing changes to source or image application A in one or more application data log folders, receiving an input from a user to select source application data A to be synchronized with image application data A, and synchronizing the source application data A with the image application data A. The method may be further comprised of storing setting information required for the steps of monitoring, storing, receiving an input, and synchronizing.

### BRIEF DESCRIPTION OF THE DRAWINGS

FIG. 1 shows a prior art block diagram of various computer software applications running in a computer system;

FIG. 2 shows a prior art block diagram of a structure for application data for a computer application program;

FIG. 3 shows a prior art block diagram of an example of application data for a computer application program where the application data includes a plurality of contacts records;

FIG. 4 shows a prior art first table including source data for a source computer file and a prior art second table including image data for a computer application program;

FIG. 5 shows a prior art first table including source application data and a prior art second table including image application data after they have been changed independently;

FIG. 6 shows a first table including source data and a second table including image data after source data has been backed up to image data and after independent changes were made from source to image;

FIG. 7 shows a table of results of a synchronization where the changes in either the source or destination side are made to the other side;

FIG. 8A shows a block diagram of the interaction between application data A and various modules of an embodiment of the present invention;

FIG. 8B shows a block diagram of sample source application data, destination application data, an application data monitor, an application data sync engine, and an application data log file in accordance with an embodiment of the present invention;

FIG. 9 is a flow chart of a start monitor computer software procedure;

FIG. 10 is a flow chart of a computer software procedure which starts logging changes in application data done by one or more computer software applications;

FIG. 11 is a flow chart of a computer software procedure which causes an item R to be logged under a Folder L;

FIG. 12 is a flow chart of a computer software procedure which determines whether a change in item R is a result of an ongoing synchronization;

FIG. 13 is a flow chart of a computer software procedure which starts the process of synchronizing selected files;

FIG. 14 is a flow chart of a computer software procedure which one-way synchronizes from application source data to image or destination data; i.e. the procedure applies changes of application data to its image;

FIG. 15 is a flow chart of a computer software procedure which two-way synchronizes from application source file data and its image or destination data i.e. it applies changes of application data to its Image and vice versa;

FIG. 16 is a flow chart of a computer software procedure that applies a source log of the source application data to destination application data;

FIG. 17 is a flow chart of a computer software procedure that calls various other computer software procedures or methods depending upon an action parameter passed to the procedure shown in FIG. 17;

FIG. 18 is a flow chart of a computer software procedure that determines what action is to be done, given a set of actions that happened on the source data and the destination data;

FIG. 19 is a flow chart of a computer software procedure that prepares the name of an application data log folder where changes of a particular application data source and destination are to be logged;

FIG. 20 is a flow chart of a computer software procedure that is responsible for moving new changes from the point the synchronization started to a new folder location;

FIG. 21 is a flow chart of a computer software procedure that determines the respective log folder depending on the application data name, image data name and monitor session ID (identification);

FIG. 22 is a flow chart of a computer software procedure that finds the type of change that occurred on a data item D;

FIG. 23 is a flow chart of a computer software procedure that checks if an Item R is present in a Folder P in computer memory;

FIG. 24 is a flow chart of a computer software procedure that checks if an item R is present in a Folder P in a Log file in computer memory;

FIG. 25 is a flow chart of a computer software procedure that gets the path of a parent folder of item R stores the name of the path of the parent folder in computer memory;

FIG. 26 is a flow chart of a computer software procedure that records items that are moved into the Application Data Log Folder;

FIG. 27 is a flow chart of a computer software procedure that gets the path of a parent folder of item R and stores it in computer memory;

FIG. 28 is a flow chart of a computer software procedure that gets the path of a parent folder of an item R and stores it in computer memory;

FIG. 29 is a flow chart of a computer software procedure that gets the path of parent folder of item R and stores it in computer memory;

FIG. 30 is a flow chart of a computer software procedure that calls a function and passes the function various parameters to get the file handle to the parent folder in the Log File and stores the file handle in a folder P;

FIG. 31 is a flow chart of a computer software procedure that given an item R, gets the item R's image item from another Folder L; and

FIG. 32 is a description of the Application Data and Application Data Log Folder as a collection of records and folders.

### DETAILED DESCRIPTION OF THE DRAWINGS

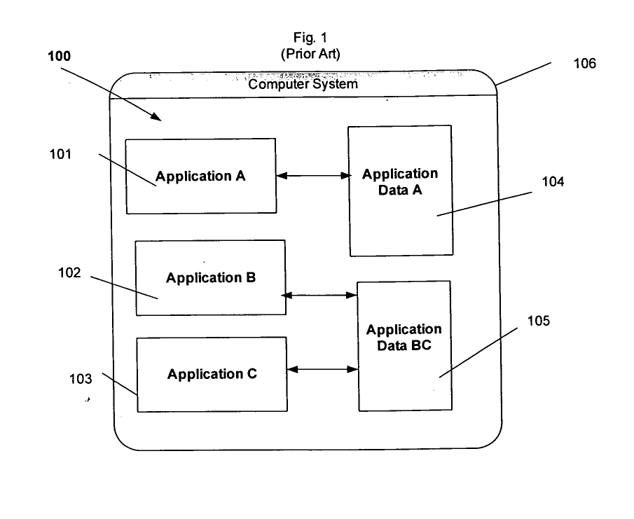

FIG. 1 shows a prior art block diagram 100 of various computer software applications running in a computer system 106. The computer software applications include Application A or 101, Application B or 102, and Application C or 103. Each application has application data. For example, Application A or 101 has application data 104. Application B or 102 has application data BC or 105. Application C or 103 also has application data BC or 105. The application data may be stored in computer memory in any known manner.

Application data, such as 104 and 105 can grow to very large sizes and if the computer software applications are important, there will be a need to backup or synchronize the application data, such as 104 and 105. Backup of application data, typically means moving changes in an application data computer file from a source application data computer file to a destination or image application data computer file. Synchronization of application data, typically means two way movement of changes, so that changes to a source application data computer file are made to a destination and changes to a destination application data computer file are made to a source. As the size of application data, such as 104 and 105 increases, it becomes more and more difficult to either backup or synchronize the data. The present invention, in one or more embodiments, provides one or more methods for solving this problem.

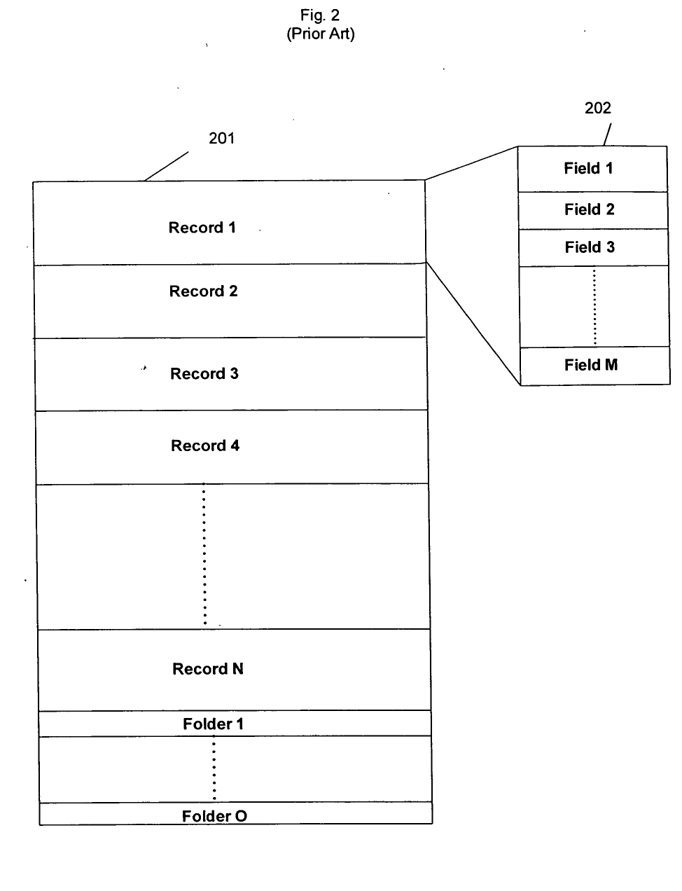

FIG. 2 shows a prior art block diagram 201 of an application data structure, for example, for application data 104 of FIG. 1. The application data structure may include a plurality of records such as records 1 through N and a plurality of folders such as folders 1 through O (letter “O” not the number 0 ) shown in FIG. 2. Each of records 1 through N, may include a plurality of fields. For example, record 1 or record 202 may include fields 1 through M. Each of folders 1 through the letter O may be comprised of a plurality of folders and records. Each of records 1 through N may be comprised of a collection of well defined fields.

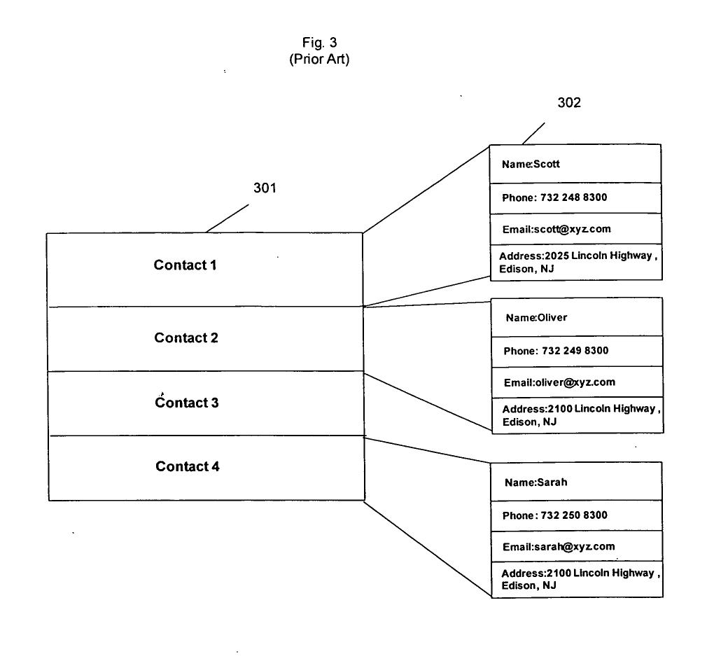

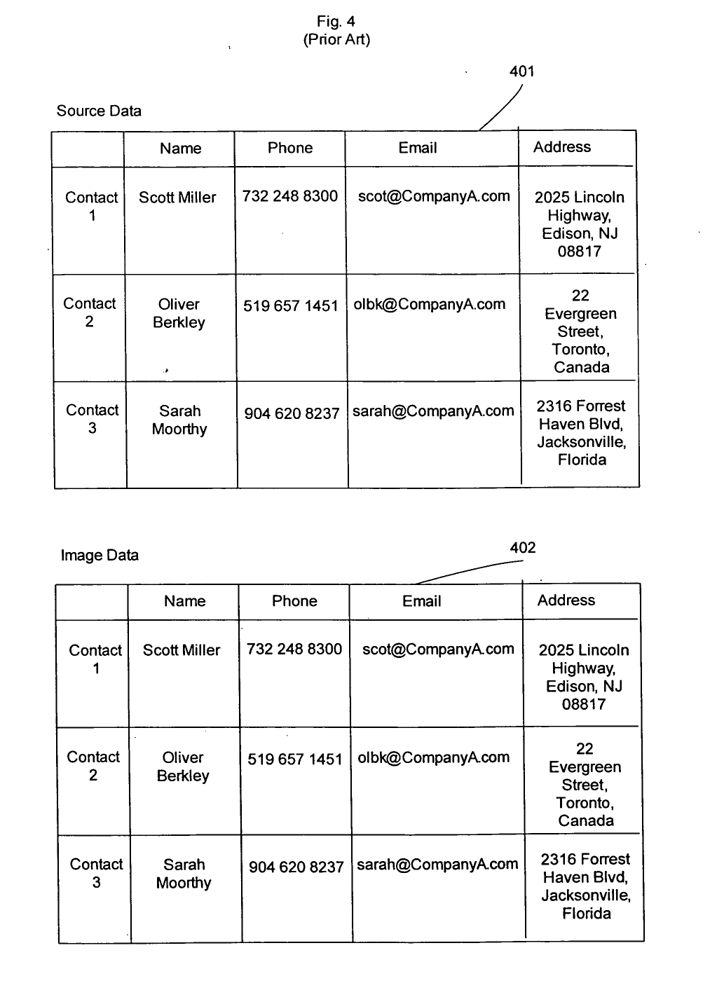

FIG. 3 shows a prior art block diagram 301 of an example of application data for a computer application program where the application data includes a plurality of contacts records 1 through 4. Contact records 1 through 4 each contain data concerning a person's name, phone, e-mail address, and physical address which are stored in a computer memory. For example, contact record 1 includes data 302 including a name, phone number, e-mail address, and physical address for “Scott”. FIG. 4 shows a prior art first table 401 including source application data and a second table 402 including image application data after the source application data and the image or destination application data have have been synchronized. Since the image application data table is the image or replica of the source application data table and has been already synchronized, the source application data and the image application data both contain the same data for contact records 1-3.

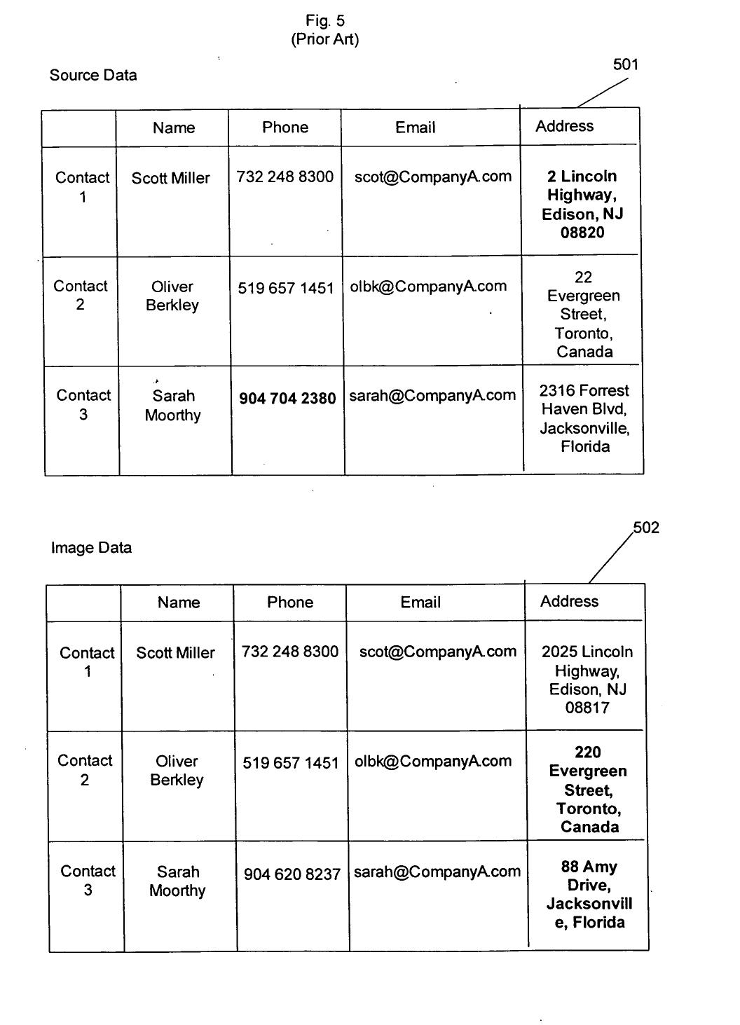

FIG. 5 shows a prior art first table 501 including source application data and a second table 502 including image or destination application data. FIG. 5 shows the source application data and the image application data after they have been independently changed. Certain fields in the individual records have been changed independently in the source and image application data. For example, the address for the contact 1 record for the source application data has been changed from “2025 Lincoln Highway, Edison, N.J. 08817” in FIG. 4, to “2 Lincoln Highway, Edison, N.J. 08820 in” in FIG. 5. Also the phone number has been changed for the contact 3 record for the source application data from “904 620 8237” in FIG. 4 to “904 704 2380” in FIG. 5. Also the addresses shown from the contact 2 and 3 records for the image application data have been changed from what is shown in FIG. 4 to what is shown in FIG. 5.

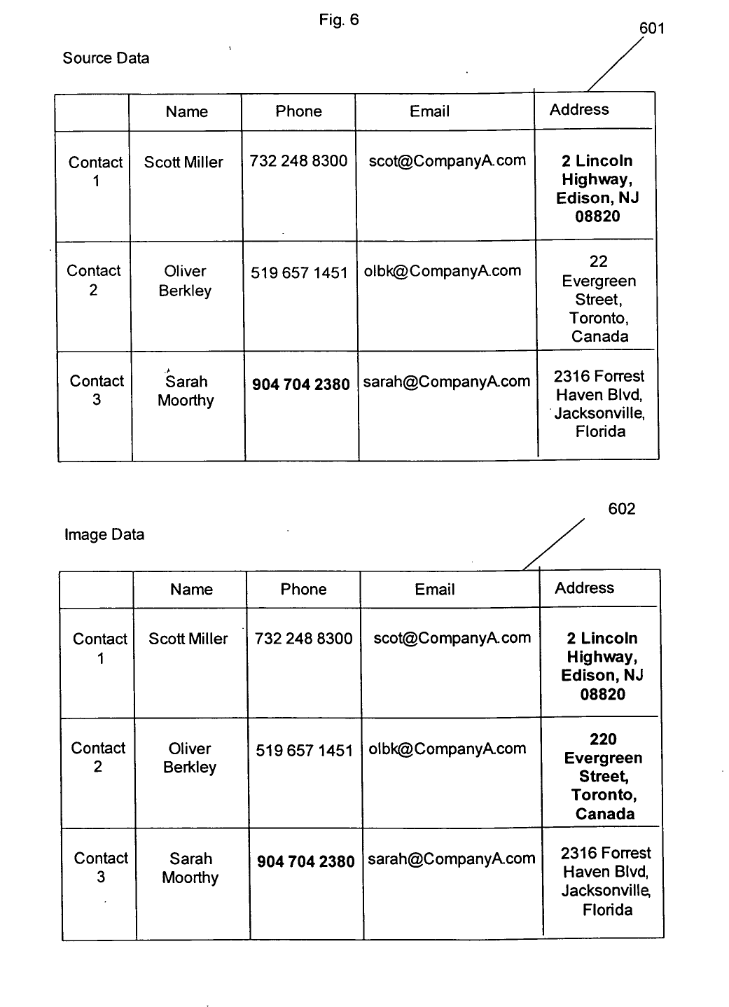

FIG. 6 shows a first table 601 including source application data and a second table 602 including image application data after source application data has been backed up to image application data and after independent changes were made to source application data and image application data, in accordance with an embodiment of the present invention Thus the change to the contact 1 record of the source application data has now been backed up to the contact 1 record of the image application data. Also the change to the phone number of the contact 3 record of the source application data has been backed up to the contact 3 record of the image application data. Notice that contact 3 address of image has been changed from FIG. 5 to FIG. 6 while contact 2 of image has not been changed from FIG. 5 to FIG. 6. All the changes in the source application data are made to the destination application data. However the destination application data changes that were independent are overwritten. For example, the address for contact 3 changed in the image data from that shown in FIG. 4 to that shown in FIG. 5. This change in contact 3 address is overwritten in image data 602 of FIG. 6, because contact 3 record was changed in source. However, contact 2 record in image data of FIG. 6 is not overwritten because source data did not change from FIG. 4 to FIG. 5. This example highlights the unit or granularity of backup and synchronization process in accordance with an embodiment of the present invention In this case, we synchronize record by record. So in backup process, we keep track of records which change in or on the source data and apply those in or to the image data. It should be noted that the granularity of backup can be changed to a lower level like a field in the record of the application data and a method in accordance with an embodiment of the present invention can be appropriately adjusted to deal with it. However, it is important to define the granularity as the choice of granularity defines how a method in accordance with an embodiment of the present invention will behave when there are changes on both the source and destination in a level below the granularity of backup and synchronization. In our example, contact records 1 & 3 are changed in source (from FIG. 4 to FIG. 5) and those changes make their way to destination (from FIG. 5 to FIG. 6). On the other hand, contact record 2 is still the same in the source (from FIG. 4 to FIG. 5) and therefore, it is not backed up to the destination (i.e. contact record 3 of image data 602 remains the same in FIG. 5 and 6 and does not become the same as the contact record 3 of source data).

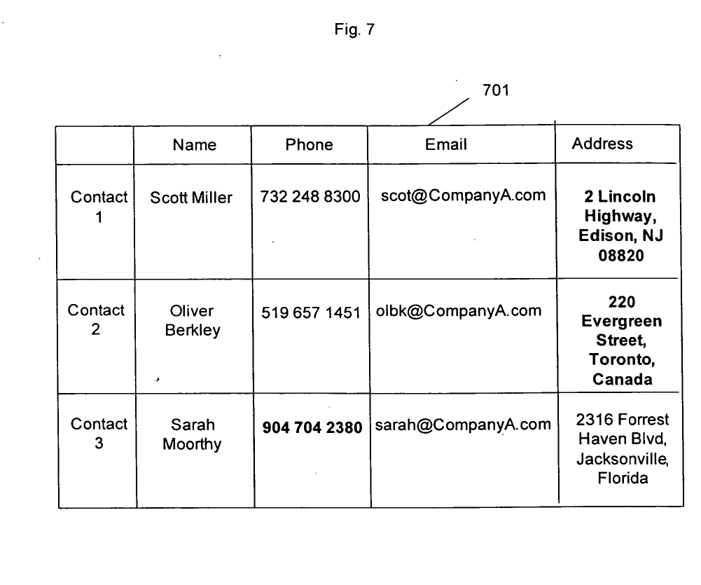

FIG. 7 shows a table 701 of results of a synchronization in accordance with an embodiment of the present invention, where the changes in either the source application data or destination application data side are made to the other side. The examples shown by FIG. 7 also point out limitations in the synchronization method introduced by the selection of granularity level of synchronization. It should be noted that the granularity of synchronization can be changed to a lower level like a field in the record of the application data and a method in accordance with the present invention can be appropriately adjusted to deal with that. However, it is important to define the granularity as the choice of granularity defines how the method will behave when there are changes on both the source and destination in a level below the granularity of backup and synchronization. Because records are being dealt with, the records that have changed at both sides are identified If a record has changed on both sides, then an embodiment of the present invention takes precedence of one side rather than merging the changes. For example, both sides (source and image) could have made a change to the same field .eg Source puts “88 Amy Drive” and destination puts “8888 Amy Drive”. In that case, an embodiment of the present invention has to override one side's changes. So in one of the levels, precedence needs to be determined. An embodiment of the present invention does this at the row level. Changing the level won't change the basic method of an embodiment of the present invention. In this example, the table 701 displays both the data in the source application data and the data in the destination application data after synchronization.

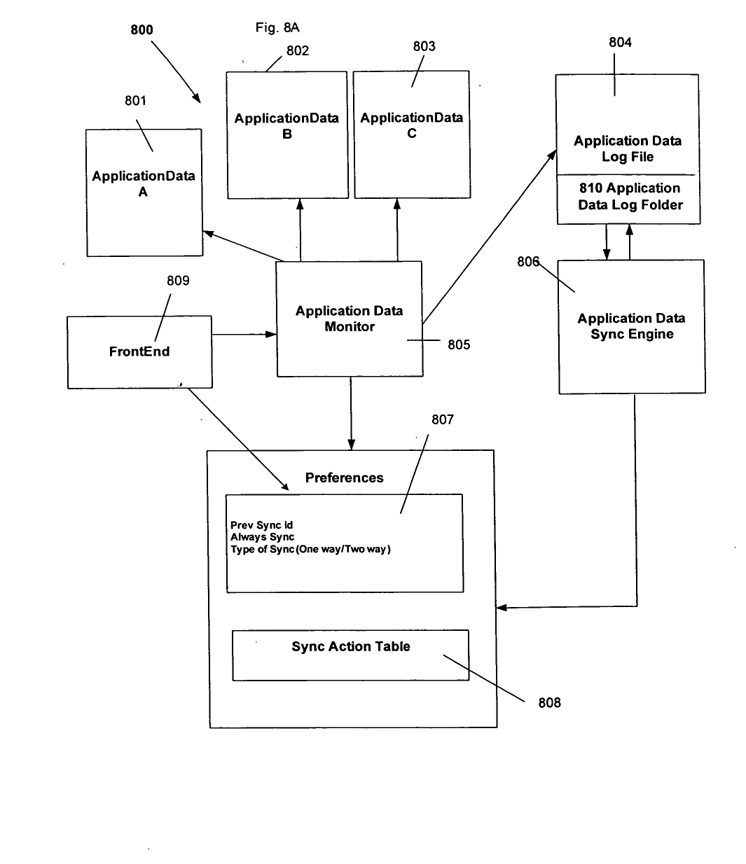

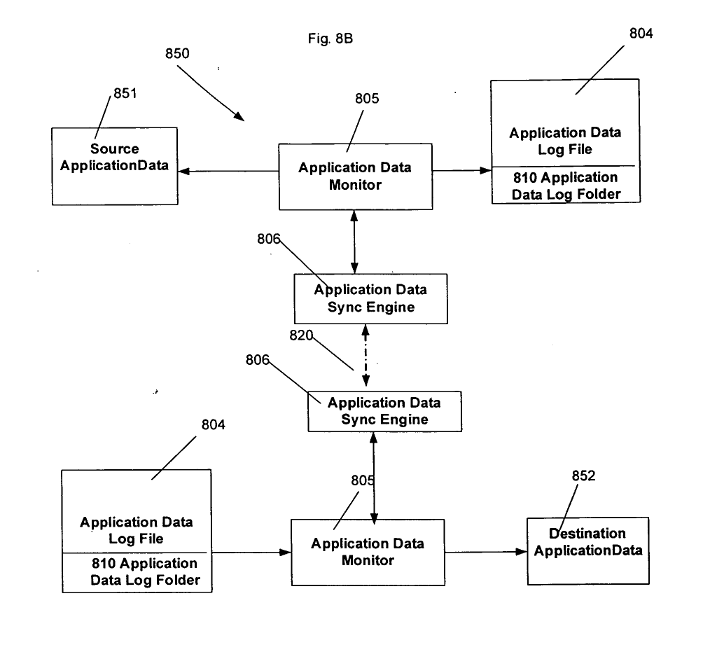

FIG. 8A shows a block diagram 800 of the interaction between Application Data A or 801, and various modules of one embodiment of the present invention. The block diagram 800, in addition to Application Data A or 801, shows Application Data B or 802, Application Data C or 803, Application Data Log File 804, Application Data Monitor 805, Application Data Sync Engine 806, Preferences file 807, Sync Action Table 808, Front End 809, and Application Data Log folder 810. Application Data A or 801, B or 802 and C or 803 are data bases on a computer whereas Application Data Monitor 805, Application Data Sync Engine 806 and Front End 809 are typically implemented by computer software programs running on a computer. Application Data Log File 804 is also a data base on a computer, with the same structure as the data base that it is monitoring (in this case Application Data A or 801, B or 802 or C or 803 ). Application Data Log File 804 is made up of different Application Data Log Folders 810, which are stored on a computer. Preferences 807 is also a database on a computer storing collection of preferences to be shared by Front End 809, Application Data Monitor 805 and Application Data Sync Engine 806. Sync Action Table 809 is a part of Preferences 807.

Referring to FIG. 8A, the Application Data Monitor 805 monitors some of the application data of interest, such as for example Application Data A, 801. The changes to Application Data A, 801, are stored in a folder in one or more application data folders of Application Data Log Folder 810 in Application Data Log File 804. These changes to Application Data A 801 may be done by one or more than one computer software applications or programs running on any computer.

Preferences file 807 stores all the settings information required by Application Data Monitor 805, Front End 809, and the Application Data Sync Engine 806.

Through the Front End 809, a user can select various Application Data that are to be synced, such as Application Data A 801, provide settings required to monitor and sync the same. A user can trigger a synchronization process through the Front End 809. The Sync Action Table 808 is a part of the Preferences File 807. It has the configuration instructions for the actions to be performed by Sync engine for a source-destination change. These actions can be default ones implicitly or set by the user to override the default settings. The Application Data Sync Engine 806, when activated synchronizes source application data with image application data for all the Application Data A 801, B 802, C 803 or one of the selected Application Data of 801, 802, or 803.

FIG. 8B shows a block diagram 850 of Source Application Data 851, Destination Application Data 852, an Application Data Monitor 805, an Application Data Sync Engine 806, and an Application Data Log File 804, which includes an Application Data Log Folder 810. The Application Data Monitor 805 monitors both the Source Application Data 851 and the Destination Application Data 852 and logs changes to either in the Application Data Log File 804. These changes are then applied by the Application Data Sync Engine 806 when triggered. I.e. changes to the Source Application Data 851 are applied to the Destination Application Data 852 and changes to the Destination Application Data 852 are applied to the Source Application Data 851. Source Application Data 851 and Destination Application Data 852 may reside in the same or different computer networks as defined by the nature of the link 820. If the Source Application Data 851 and the Destination Application Data 852 are in the same computer network, one instance of Application Data Sync Engine 806, Application Data Monitor 805 and Application Data Log File 804 may be sufficient for both Source Application Data 851 and Destination Application Data 852. However, if the Source Application Data 851 and Destination Application Data 852 reside in different computer networks, for efficiency purpose, it would be better to consider a distributed architecture where operations on Source Application Data 851 and Destination Application Data 852 for backup and synchronization as described in this method are done by their own instance of Application Data Sync Engine 806, Application Data Monitor 805 and Application Data Log File 804 which are in the same computer network as the corresponding Application Data. In this distributed case, the communication between the two networks happens only through the Application Data Sync Engine 806 over the existing connection between the two networks. The type of connection can be dialup, wireless, internet, VPN or any other type of connection. It should be noted that even though, this example describes one Source Application Data 851 and one Destination Application Data 852, this architecture can easily be expanded to include multiple source Application Data 851 and multiple Destination Application Data 852. This is easy since for each source and destination combination, there is a unique Application Data Log Folder 810. If there are multiple source and destination Application Data doing two way synchronization, it is best to have each Application Data to be synchronized by having one master Application Data and every other Application Data synchronizing with this Application Data.

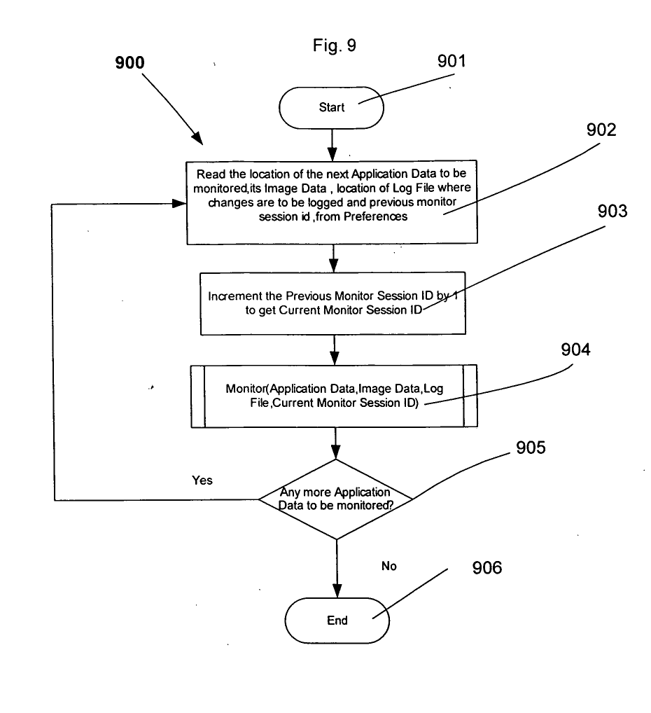

FIG. 9 is a flow chart 900 of a start monitor computer software procedure. The start monitor computer software procedure triggers the process of monitoring all of the application data, such as all of Application Data A 801, Application Data B 802, and Application Data C 803, on both source and destination application data for each of the Application Data A 801, B 802, and C 803 for changes. The procedure starts at step 901. At step 902, the computer or processor running the start monitor procedure reads the information about the particular application data to be monitored from the Preferences File 807 shown in FIG. 8A. There can be multiple application data that can be monitored by Application Data Monitor 805. Then at step 903, the processor or computer running the start monitor computer software procedure gets the current monitor session identification by incrementing the last monitor session identification which is read from the Preferences File 807 shown in FIG. 8A. Every monitor session has a unique identification.

The computer or processor running the start monitor procedure then calls a Monitor( ) function at step 904, supplying the Monitor( ) function with the location of the particular source Application Data, its Image Application Data, location of Application Data Log File 804 for the particular Application Data and the current monitor session identification. The Monitor( ) function called at step 904, starts monitoring the particular Application Data for changes. If there are any more Application Data to be monitored at step 905, the monitor procedure goes back to step 902 else the monitor procedure ends or is exited at step 906.

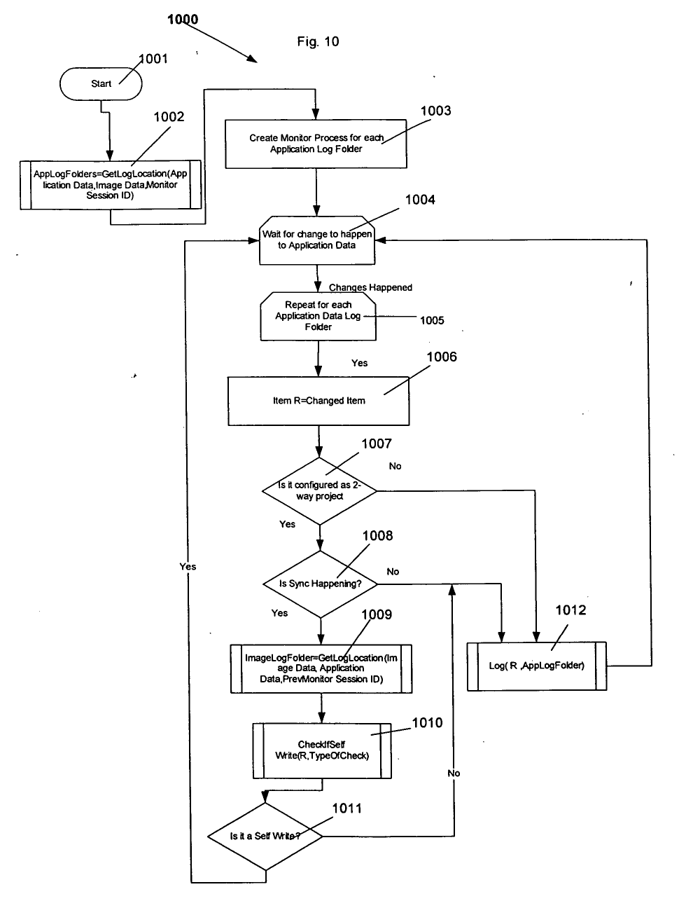

FIG. 10 is a flow chart 1000 of a computer software procedure which starts logging the changes of application data done by one or more computer software applications. The function or computer software procedure shown in FIG. 10 actually starts logging the changes of Application Data done by one or more Applications into the appropriate Application Data Log Folder 810 in Application Data Log File 804 shown in FIG. 8A. The procedure starts or is entered at step 1001. Next the procedure of FIG. 10 calls GetLogLocation ( ) at step 1002, supplying the Source Application Data, Image Application Data and Monitor Session ID (identification) to the GetLogLocation( ) function. The GetLogLocation( ) function gets the Application Data Log Folder 810 for the current Application Data source and destination combination in the Application Data Log File 804 and stores its value in a variable named AppLogFolder in a computer memory. Subsequently, the step 1003 sets a process that starts monitoring any changes occurring in the particular Application Data, including changes in source application data or image application data for the particular Application Data. There may be different ways of doing this which may be Application Data dependent. The current invention generally does not deal with how to set the monitoring process. It assumes there is a way to monitor the changes and provided it exists, and based on that, an Application Data Monitor 805 process can be started that can start the actual real time monitoring process. Step 1003 of FIG. 10, starts an Application Data Monitor 805 process corresponding to a given Application Data source and destination. The subsequent steps shown in FIG. 10, are done in the context of the process or thread of Application Data Monitor 805 shown in FIG. 8A, which is a separate thread or a separate process of step 1002. In the next step 1004, the computer software procedure of

FIG. 10, waits (by running in the background as a background process as long as the system is configured to run unless the host systems are restarted after which the monitor process starts again) for changes to occur to Application Data. If a change is detected (in step 1005 by virtue of having the monitor process set in step 1003?), the changed item is noted with all the relevant details in a memory store R in step 1006. Next the computer running the computer software procedure at step 1007 sees if this is a two-way project. Step 1007 is needed to avoid syncing the changes by the synchronization process itself, which can happen in a two way synchronization. If it's a two-way project, step 1008 checks for an ongoing synchronization. In absence of ongoing synchronization, there can't be a change done by the synchronization engine, therefore the computer running the computer software procedure calls the function Log ( ) at step 1012, supplying the function Logo with the cached item and AppLogFolder to log it in Application Data Log File 804.

If the Application Data Monitor 805 detects an ongoing synchronization in step 1008, the Application Data Monitor 805 calls GetLogLocation( ) at step 1009 to get the Application Data Log Folder 810 for the Image Application Data's previous monitor session and stores its value in the ImageLogFolder. Then the computer running the procedure of FIG. 10 calls function CheckIfSelfWrite ( ) at step 1010 to determine if the change that has occurred is due to the ongoing synchronization. For example, assume Application Data A 801 and B 802 of FIG. 8A are configured for a two-way synchronization. Hence, both Application Data A 801 and B 802 will be monitored. When the synchronization is triggered, changes of Application Data A 801 would be applied to Application Data B 802 and vice versa. Now, when logs are being applied, say from Application Data A 801 to Application Data B 802, the Application Data B 802 constantly changes. These very changes are caught by the Application Data Monitor 805 and it'll try to log them in the Application Data Log Folder 810 of Application Data B 802. These changes are called Self Writes. Since these are logs that are being applied they should not be logged.

If it's a self write the Application Data Monitor 805 of FIG. 8A does not log the change and goes back to step 1004 of FIG. 10. If it's not a Self Write, the Application Data Monitor 805 calls the function Log ( ) at step 1100 of FIG. 10, supplying the function Log( ) with the cached item and the variable AppLogFolder to log it in Application Data Log File 804. Once the Application Data Monitor 805 logs the change, the Application Data Monitor 805 again waits at step 1004 for further changes to occur. If it is a one-way project, Application Data Monitor 805 simply logs the changes by going to step 1012 without making a check for self writes.

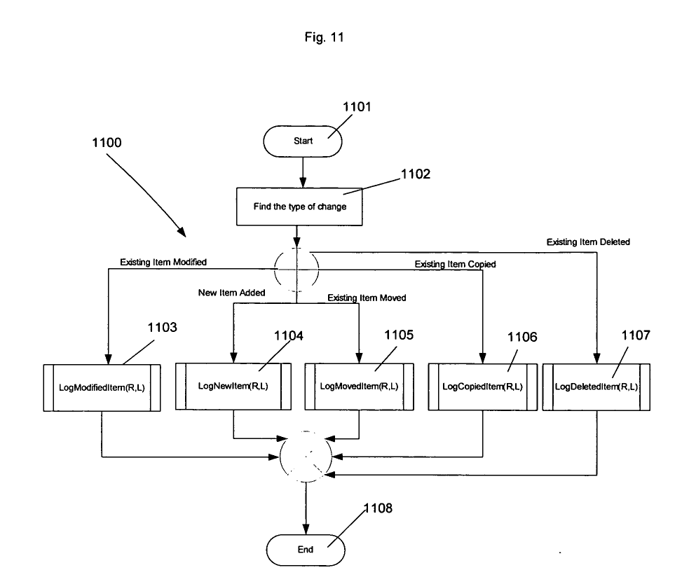

FIG. 11 is a flow chart 1100 of a computer software procedure which causes the item R to be logged under Folder L of Application Data Log Folder 810. The computer software procedure starts at step 1101. (Application Data Folder 810 is unique for a given combination of Source Application Data 851, Destination Application Data 852 and Synchronization ID. The current Application Data Folder 810 was determined in the step 1002. The type of change is determined at step 1102 i.e. whether item R is new, moved, modified, deleted, or copied. It is assumed that Application Data Monitor 805 can determine the type of change. This invention does not deal with how to go about determining the type of change. If an item R is new, function LogNewItem ( ) is called at step 1104. If an item R or has been modified, function LogModifiedItem ( ) is called at step 1103. If an item R has been moved, function LogMovedItem ( ) is called at step 1105. If an item R has been deleted, function LogModifiedItem ( ) is called at step 1107. If an item R has been copied, function LogModifiedItem ( ) is called at step 1108.

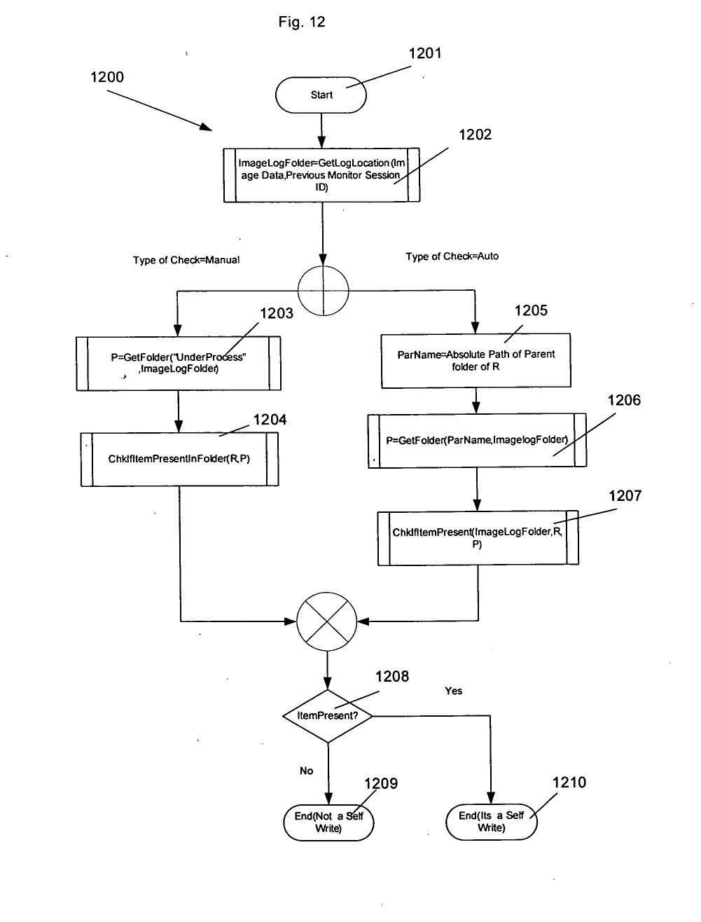

FIG. 12 is a flow chart 1200 of a computer software procedure which determines whether the change in item R is a result of an ongoing synchronization. The computer software procedure shown in FIG. 12 determines whether the change in item R is a result of an ongoing synchronization. The procedure starts at step 1201. Next the computer running the procedure of FIG. 12, calls GetLogLocation( ) at step 2100 to get the Application Data Log Folder 810 for the Image Application Data's previous monitor session and stores its value in the variable or temporary memory location ImageLogFolder. ImageLogFolder contains the changes of Image Application Data in the previous monitor session. Type of to determine if the current change is a self write can be either manual or automatic. The method to be used is a user preference that is read from Preferences File 807 of FIG. 8A. In a manual method, the Application Data Sync Engine 806 for the image file or destination file takes the responsibility of logging the item it is currently synchronizing (in this case Item R) into a folder “UnderProcess” in the destination or image Application Data Log Folder 810. Once the changes are entered into destination or image Application Data Log Folder 810, this entry is removed from the Application Data Log Folder 810 by Application Data Sync Engine 806. If the Application Data Monitor 805 for particular destination or image Application Data finds the current monitored entry R present in the destination Application Data Log Folder 810 in the “UnderProcess” folder, it is assumed to be a self write and therefore ignored.

A manual check calls function GetFolder ( ) at step 1203 of FIG. 12, to get access to a folder named “UnderProcess” in the ImageLogFolder. This folder contains all the items which are being processed by an ongoing synchronization. Then the computer running the procedure of FIG. 12 calls function ChkIfItemPresentInFolder ( ) at step 1204, to check if item R is present in folder “UnderProcess”. If it is present, the item R is changed due to the sync process i.e. it's a Self Write else it's not a Self Write.

Automatic check first finds the hierarchical path of the parent of item R in step 1205. Then it uses this path in function GetFolder ( ) at step 1206 to access the parent folder under ImageLogFolder i.e. P. Then the procedure of FIG. 12 calls function ChkIfItemPresent ( ) at step 1207 to check if item R is present in the folder P. If it is present, the item R is changed due to the sync process i.e. it's a Self Write else it's not a Self Write.

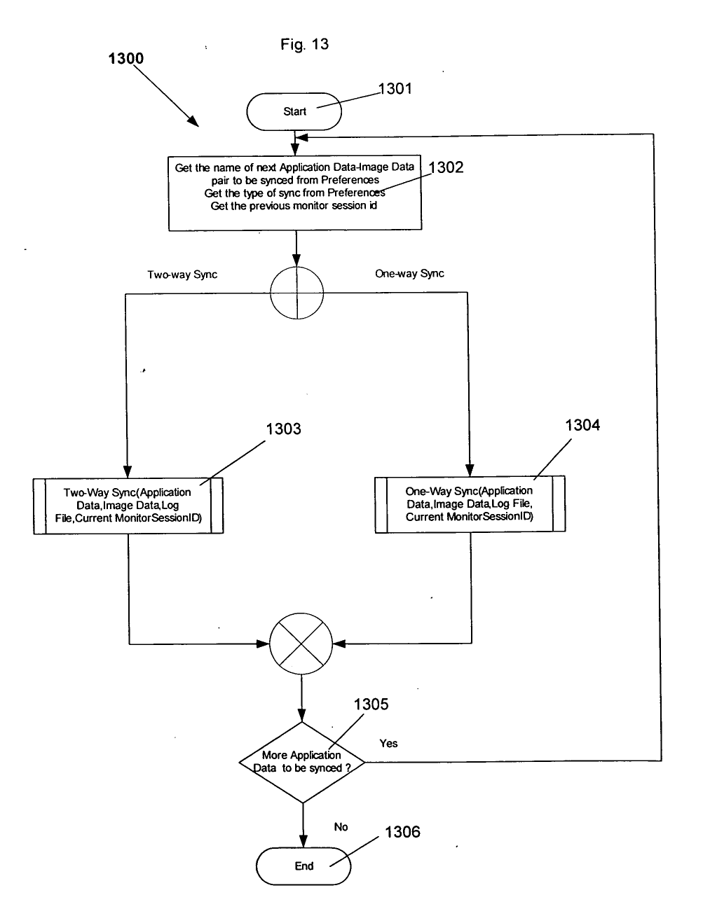

FIG. 13 is a flow chart 1300 of a computer software procedure which starts the process of synchronizing selected files. The procedure starts at step 1301. The procedure shown by flow chart 1300 may be run by Application Data Sync Engine 806 shown in FIG. 8A. At step 1302, Application Data Sync Engine 806, which be be comprised of computer software running on a computer, retrieves the name of source application data, its image application data, type of sync and monitor session identification from the Preferences File 807. If type of sync is two-way it calls function Two-Way Sync ( ) at step 1303 to do a two-way synchronization of the source application data and its image application data and passing the name of the source application data, its image application data, type of sync monitor session identification and Log file name. If type of sync is one-way the procedure shown in FIG. 13 calls function One-Way Sync ( ) at step 1304 to do one-way synchronization of the source application data and its image application data by passing Application Data Sync Engine 806 the name of source application data, its image application data, type of sync monitor session identification and Log file name. In step 1305 a computer running computer software implementing the procedure in FIG. 13 checks to see if there are any more application data to be synced. If yes the procedure goes back to step 1302 else the procedure is exited at step 1306.

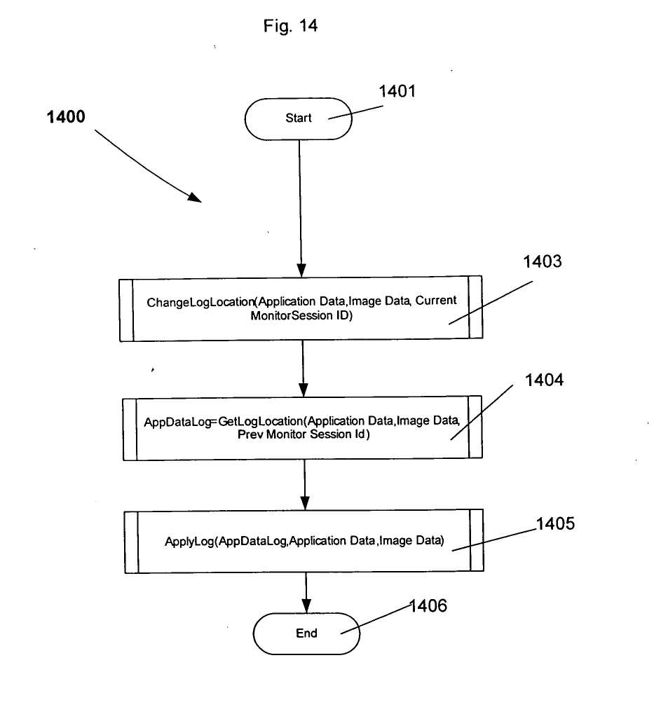

FIG. 14 is a flow chart 1400 of a computer software procedure, which one-way synchronizes from application source data to image or destination application data; i.e. it applies changes of source application data to its Image. The procedure shown in FIG. 14 one-way synchronizes from source Application Data to Image application Data i.e. it applies changes of source Application Data to its Image application data. The procedure starts at step 1401. At step 1402 Application Data Sync Engine 806 increments the Current Monitor Session identification. This sets the Monitor Session identification of the next monitor session.

Then the procedure of FIG. 14, calls function ChangeLogLocation ( ) at step 1403, passing it the source application data, image application data and new value of Current Monitor Session ID. This function changes the location in Application Data Log File 804 where modifications to source application data are to be logged. This ensures that the Application Data monitor 805 logs the changes, if any, happening simultaneously as the sync process is going on, in a different location. In this way the procedure of FIG. 14 makes sure that any changes happening to Application Data, in either source or image, from this point, starts going to a new Application Data Log Folder 810. This is to ensure that we can handle changes happening to Application Data while synchronization is happening as well as to start collecting changes from this point onwards for the next synchronization session. Then the procedure of FIG. 14, calls GetLogLocation( ) at step 1404 to get the Application Data Log Folder 810 for the Application Data's previous monitor session and stores it value in AppDataLog. The information passed to GetLogLocation ( ) are the source application data, image application data and previous Monitor Session identification. AppDataLog contains the changes of Application Data logged in the previous monitor session. Next the procedure of FIG. 14 calls function ApplyLog ( ) at step 1405 to apply the AppDataLog to the image application data. The parameters passed are the AppDataLog, the source application data and Image application data.

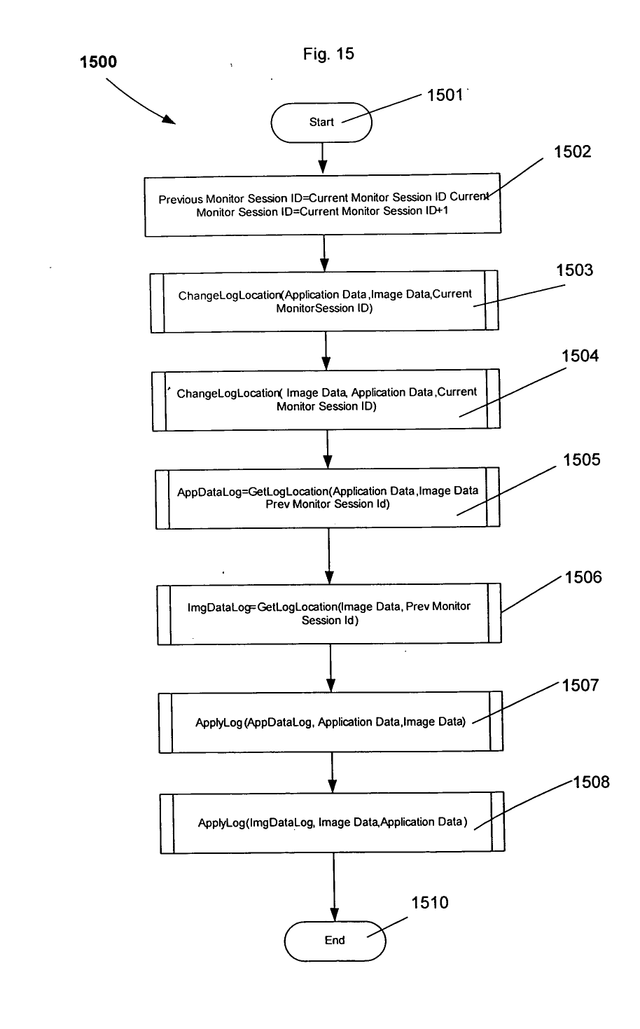

FIG. 15 is a flow chart 1500 of a computer software procedure which two-way synchronizes from application source file data and its image or destination application data i.e. it applies changes of source application data to its image application data and vice versa. The procedure of FIG. 15 two-way synchronizes from source application data and its image application data i.e. the procedure of FIG. 15 applies changes of source application data to its Image application data and vice versa. The procedure starts at step 1501. At step 1502 the procedure increments the Current Monitor Session identification. Then the procedure of FIG. 15 calls function ChangeLogLocation ( ) at step 1503, passing the function ChangeLogLocation ( ) the source application data, image application data and new value of Current Monitor Session identification. The function ChangeLogLocation( ) changes the location in Application Data Log File 804 where consequent changes to source application data 851 or image or destination application data 852 are to be logged. The procedure in FIG. 15 again calls ChangeLogLocation ( ) at step 1504 passing it the image application data, source application data and new value of Current Monitor Session identification. At step 1504 the ChangeLogLocation ( ) function changes the location in the Application Data Log File 804 where further changes to image application data are to be logged.

Then, at step 1505, the procedure of FIG. 15, calls GetLogLOcation ( ) to get the location where the changes of the source or image Application Data (851/852) were last monitored. Hence further changes to both source application data and its Image application data are logged in a different Application Data Log Folder 810 by the Application Data Monitor 805. Then, the procedure of FIG. 15 calls GetLogLocation( ) at step 1506 to get the Application Data Log Folder 810 for the source application data's previous monitor session and stores its value in the variable AppDataLog. The information passed to GetLogLocation ( ) are the Source Application Data, Image Application Data and previous Monitor Session identification.

The variable AppDataLog contains the name of the application data log folder 810 for changes on source data logged in the previous monitor session. Next the procedure of FIG. 15 again calls GetLogLocation( ) at step 1506 this time to get the Application Data Log Folder 810 for the image application data's previous monitor session and stores it value in ImageDataLog. The information passed to GetLogLocation ( ) are the image application data, source application data and previous Monitor Session identification. ImageDataLog contains the changes of Image application data logged in previous monitor session. Next the procedure of FIG. 15 calls function ApplyLog ( ) at step 1507 to apply the AppDataLog to image application data. The parameters passed are the AppDataLog, ImageDataLog, source Application Data and Image Application Data.

Then the procedure of FIG. 15 again calls function ApplyLog ( ) at step 1508 to apply the ImageDataLog to the source Application Data 851. The parameters passed are the ImageDataLog, AppDataLog, Image Application Data and the source Application Data.

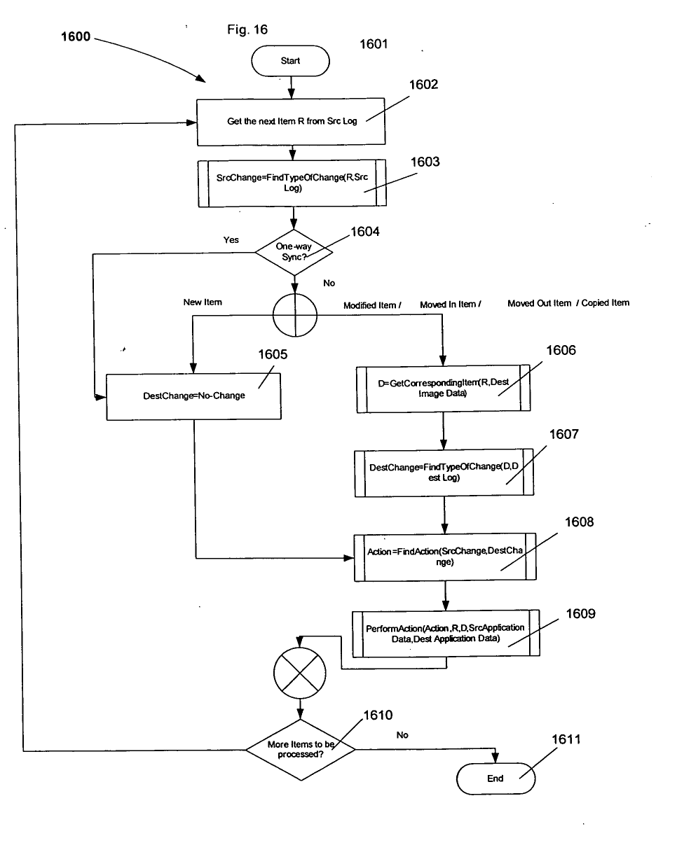

FIG. 16 is a flow chart 1600 of a computer software procedure that applies a Application Data log Folder 810 a to a given application data. The procedure of FIG. 16 applies Source Application Data log Folder 810 of any Source Application Data 851 to Destination Application Data 852 or vice verse. The procedure starts at step 1601. At step 1602, the procedure gets the next item “R” to be processed from the Source Application Data log Folder 810 for source Application Data 851 which contains all the changes made to source application data which were recorded by Application Data Monitor 805 shown in FIG. 8A. Then the Application Data Sync Engine 806 calls function FindTypeOfChange ( ) 1603, passing it the item R and Application Data log Folder 810 for source Application Data 851, to determine the type of change done on item R and stores its value in SrcChange.

At step 1604 the procedure checks the type of sync. For one-way sync, the destination change is not considered and therefore, Application Data Sync Engine 806 goes directly to step 1605, marking that we don't need to consider any changes in the destination. If the item R is a new item, we assume that this item is not there in destination; therefore, in this case also, we directly go to step 1605. If the type of change is anything else Application Data Sync Engine 806 calls function GetCorrespondingItem ( ) at step 1606 to find the corresponding item R, i.e. item D, in the destination application data. The Application Data Sync Engine 806 then calls function FindTypeOfChange ( ) at step 1607, passing it the item D and Application Data log Folder 810 for destination Application Data 851, to determine the type of change done on item D and stores its value in DestChange. The procedure of FIG. 16 then calls FindAction ( ) at step 1608, passing it the SrcChange and DestChange, to determine the action to be performed given a source-destination pair of changes and stores its value in Action.

Once the action is determined the procedure of FIG. 16 calls function PerformAction ( ), passing Action, item R, item D, Source Application Data and Dest Application Data, to execute the necessary action at step 1609.

At step 1610, the procedure in FIG. 16 checks so see if there are more items to be processed. If yes, the procedure goes to step 1602 to process more items else the procedure is exited at step 1611.

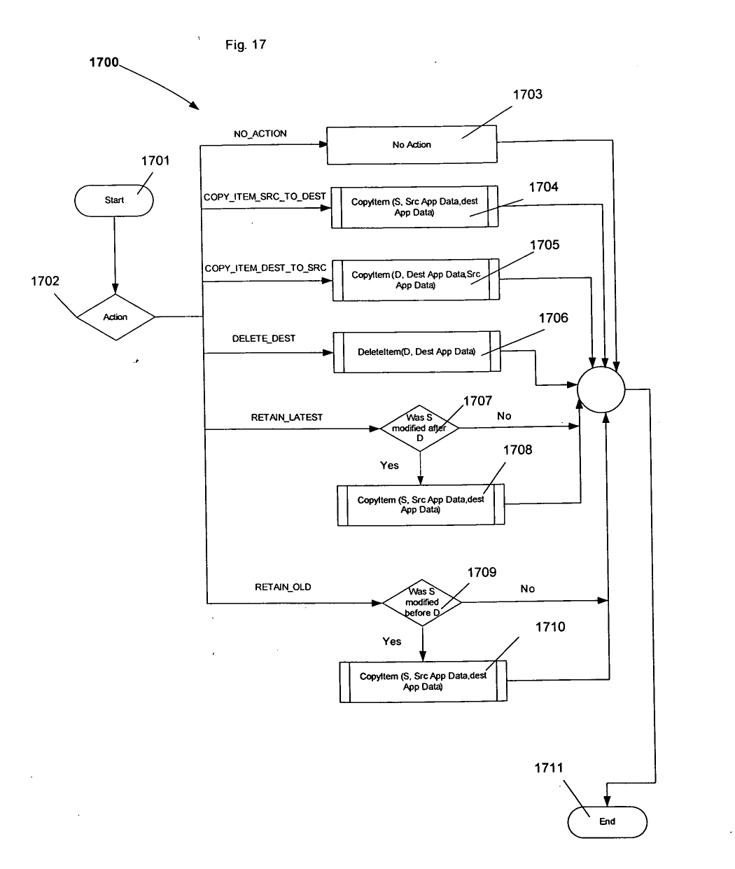

FIG. 17 is a flow chart 1700 of a computer software procedure that calls various other computer software procedures or methods depending upon an action parameter passed to the procedure shown in FIG. 17.

The procedure starts at step 1701. At step 1702 it is determined by a computer running the procedure of FIG. 17 the action to take. The possible actions are:
1. NO_ACTION taken at step 1703: Does not perform any function.
2. COPY_ITEM_SRC_TO_DEST: Calls function CopyItem ( ) at step 1704, passing it the Item S, Source Application Data, Destination Application Data, to copy item S from source Application Data to destination Application Data.
3. COPY_ITEM_DEST_TO_SRC: Calls function CopyItem ( ) at step 1705, passing it the item D, Destination Application Data, Source Application Data, to copy item from destination to source Application Data.
4. DELETE_DEST: Calls function DeleteItem ( ) at step 1706, passing it the item D, Destination Application Data to delete item D from Destination Application Data.
5. RETAIN_LATEST: First checks in step 1707 if item S was modified after item D. If yes, the procedure of FIG. 17 calls CopyItem ( ) at step 1708, passing it the item S, Source Application Data, Destination Application Data, to copy item S from Source Application Data to Destination Application Data. If no, the procedure of FIG. 17 is exited at step 1711.
   RETAIN_OLD: First checks in step 1709, if item S was modified before D. If yes, the procedure of FIG. 17 calls CopyItem ( ) 1710, passing it the item S, Source Application Data, Destination Application Data, to copy item S from Source Application Data to Destination Application Data.

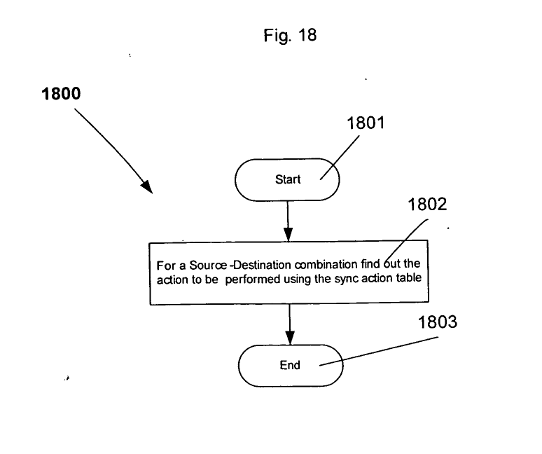

FIG. 18 is a flow chart 1800 of a computer software procedure that based on a type of change in the First Application Data and a type of change in Second Apllication Data 852, it decides what is the change to be done to the Second Application Data 851 so that the two images are in sync. Table 3 shows the format of Sync Action Table 808. It contains a two dimensional table where each row corresponds to a given change in First Application Data and every column corresponds to a given change in Second Application Data.

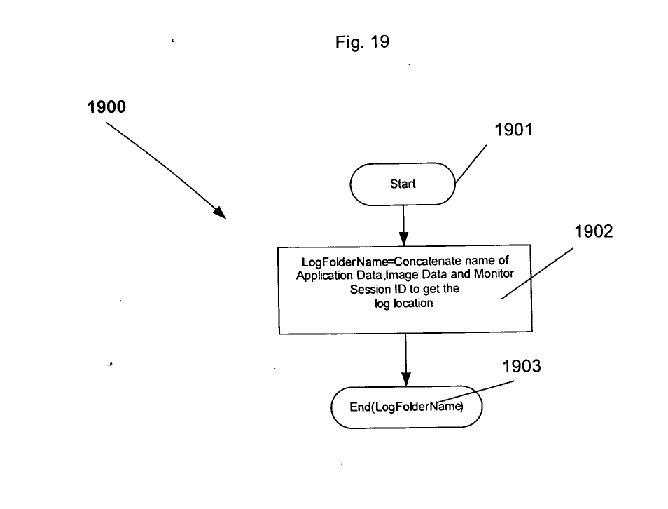

FIG. 19 is a flow chart 1900 of a computer software procedure that prepares the name of the Application Data Log folder 810 where changes to a particular application data are to be logged. To accomplish this, the procedure of FIG. 19 creates a string at step 1902 by concatenating the name of source Application Data, Image Application Data and Monitor Session Identification. The procedure of FIG. 19 starts at step 1901 and ends at step 1903.

For example assume that the names of source Application Data and its Image Application Data are Application Data A and Application Data B, respectively and the monitor session ID or identification is 45. Then the log folder name would be, Application Data A_Application Data B_45.

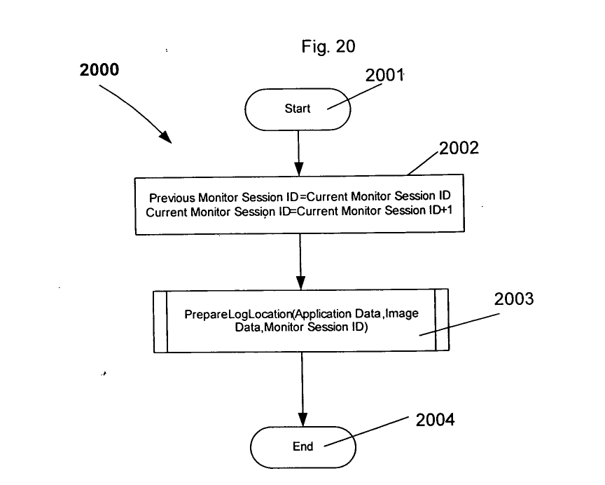

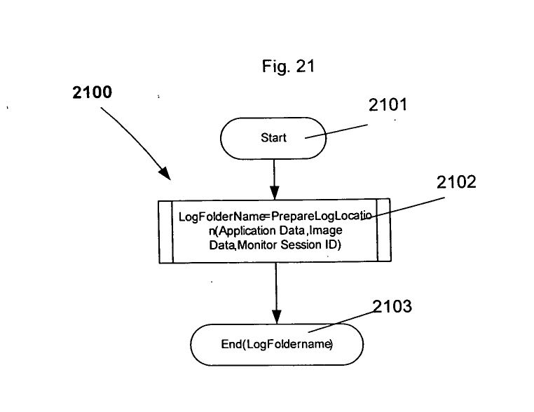

FIG. 20 is a flow chart 2000 of a computer software procedure that calls PrepareLogLocation ( ) at step 2003 passing it source Application Data name, Image application Data name, Monitor Session ID or identification. The procedure of FIG. 20 begins at step 2001 and ends at step 2004. At step 2002, the process is just incrementing the current session identification by one. Once we do this, the next step 2003 prepares the new folder name based on the sync ID (identification). This would mean that any future changes would be recorded in a new Application Data log folder 810
FIG. 21 is a flow chart 2100 of a computer software procedure that passes a source application data name, image application data name and monitor session ID (identification) to get the corresponding Application Data Log Folder 810. To do that, this procedure calls the already existing PrepareLogLOcation function with the required parameters to do that.

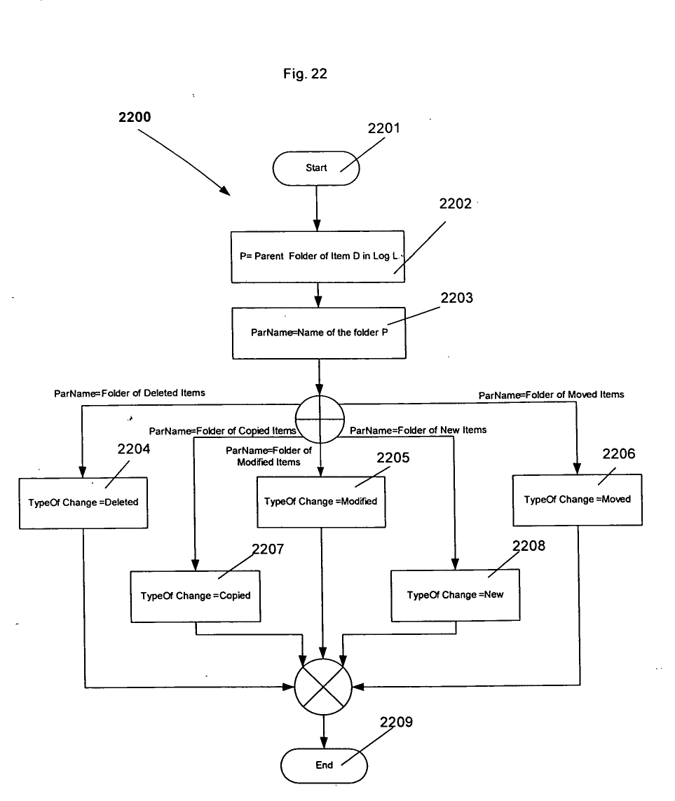

FIG. 22 is a flow chart 2200 of a computer software procedure that finds the type of change, which occurred to item D which is same as item R obtained in 1006 in FIG. 10 The procedure of FIG. 22 finds the type of change, which occurred to item D. The procedure begins at step 2201. At step 2202, the procedure gets the parent folder of item D, i.e. P. Next in step 2203, the procedure gets the name of the parent folder and stores it in variable ParName. The changed items are kept under different folders in the Log Folder, depending upon the type of change. For example, items that are deleted are kept and stored in computer memory under folder by the name “Folder of Deleted Items” and stored at step 2204, items that are new are kept and stored in computer memory under “Folder of New Items” at step 2208, items that are copied are kept and stored in computer memory under “Folder of copied Items” at step 2207, items that are modified are kept and stored in computer memory under “Folder of modified items” at step 2205, items that are moved are kept under “Folder of moved items” at step 2206. Hence to be given an item in Log Folder, to determine the change the item had undergone, we need to know the name of the parent folder.

| Name | Type of Change |
|---|---|
| Folder of Deleted Items | Deleted |
| Folder of Copied Items | Copied |
| Folder of Modified Items | Modified |
| Folder of New Items | New |
| Folder of Moved Items | Moved |

The procedure of FIG. 22 is exited at step 2209.

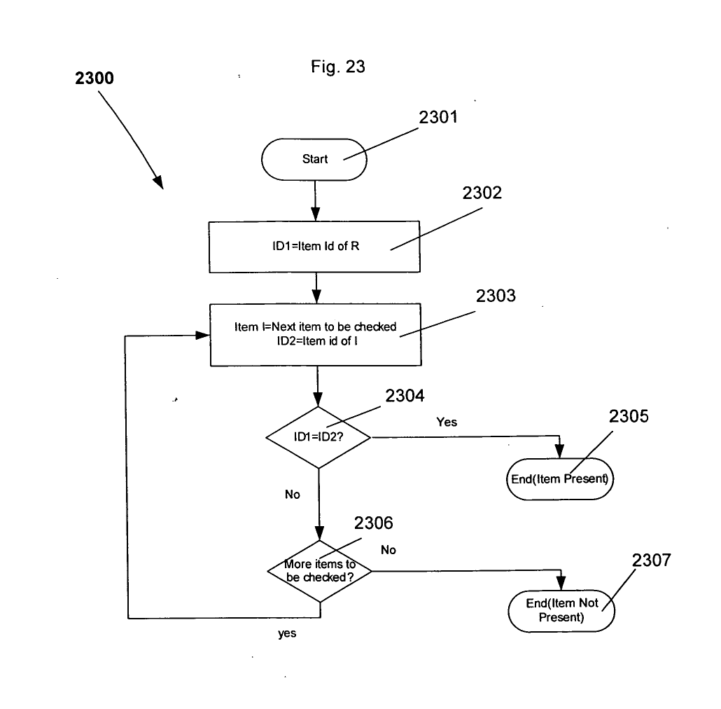

FIG. 23 is a flow chart 2300 of a computer software procedure that checks if an Item R is present in a Folder P in computer memory. The procedure of FIG. 23 checks if an Item R is present in Folder P. The procedure of FIG. 23 starts at step 2301. The procedure nexts gets the item identification of R in step 2302 i.e. ID1. Then the procedure of FIG. 23 retrieves the next item from Folder P that is to be checked and gets its item id (identification) i.e. ID2 in step 2303. The procedure checks in step 2304 if the two ids (identifications) match. If they do match, item R is present at step 2305 in Folder P else its not present at step 2307. At step 2306 it is determined if additional items need to be checked.

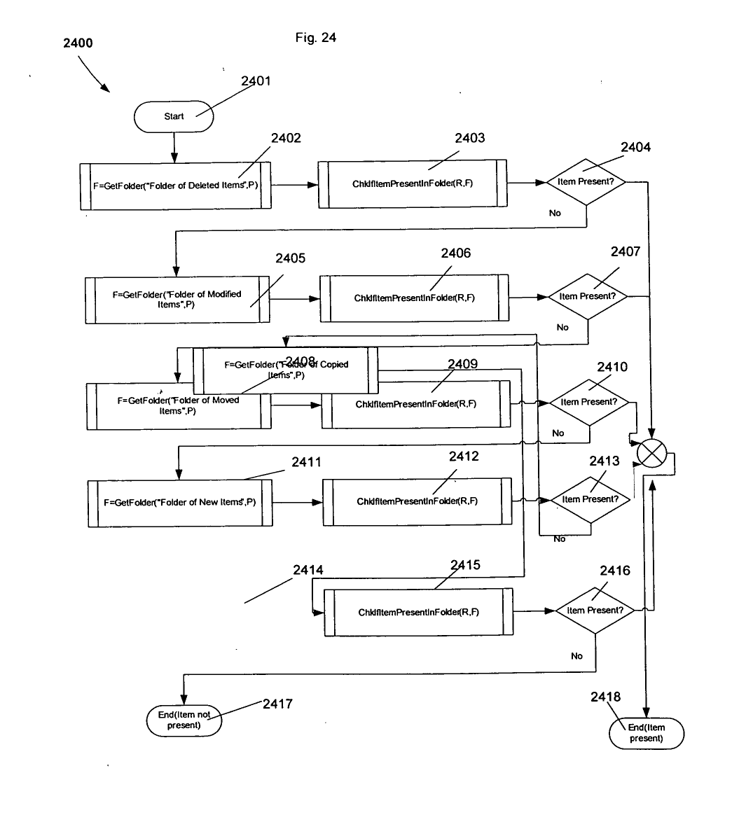

FIG. 24 is a flow chart 2400 of a computer software procedure that checks if an item R is present in a Folder P in a Log file in computer memory. The procedure of FIG. 24 starts at step 2401. The procedure of FIG. 24 checks if an item R is present in a Folder P in the Log file. The procedure of FIG. 24 checks in all the Log folders under folder P for item R. First the procedure calls GetFolder( ) at step 2402 passing it the name “Folder of Deleted Items” and Folder P to get access to folder containing deleted items under P and stores its handle in F. Then it calls ChkIfItemPresentInFolder ( ) at step 2403 and passes it item R and folder F to check if item R is present in Folder F. At step 2404, if item R is present the procedure of FIG. 24 is exited through step 2418.

If item R not present, the procedure of FIG. 24 calls GetFolder( ) at step 2405 passing it the name “Folder of Modified Items” and Folder P to get access to folder containing modified items under P and stores its handle in F. Then the procedure of FIG. 24 calls ChkIfItemPresentInFolder ( ) at step 2406 and passes it item R and folder F to check if item R is present in Folder F. At step 2407, if item R is present the procedure of FIG. 24 is exited through step 2418. If item R is not present, then the procedure of FIG. 24 calls GetFolder ( ) at step 2408 passing it the name “Folder of Moved Items” and Folder P to get access to folder containing moved items under P and stores its handle in F. Then the procedure calls ChkIfItemPresentInFolder ( ) at step 2409 and passes it item R and folder F to check if item R is present in Folder F. At step 2410, if item R is present the procedure exits through step 2418.

If item R is not present, then the procedure of FIG. 24 calls GetFolder ( ) at step 2411 passing it the name “Folder of New Items” and Folder P to get access to folder containing new items under P and stores it handle in F. Then the procedure calls ChkIfItemPresentInFolder ( ) at step 2412 and passes it item R and folder F to check if item R present in Folder F. At step 2413, if item R is present the procedure is exited through step 2418. If not present, the procedure calls GetFolder ( ) at step 2414 passing it the name “Folder of Copied Items” and Folder P to get access to folder containing new items under P and stores it handle in F. Then the procedure calls ChkIfItemPresentInFolder ( ) at step 2415 and passes it item R and Folder F to check if item R present in Folder F. In step 2416, if item R is present the procedure of FIG. 24 is exited through step 2418. If not present, the procedure is exited at step 2417.

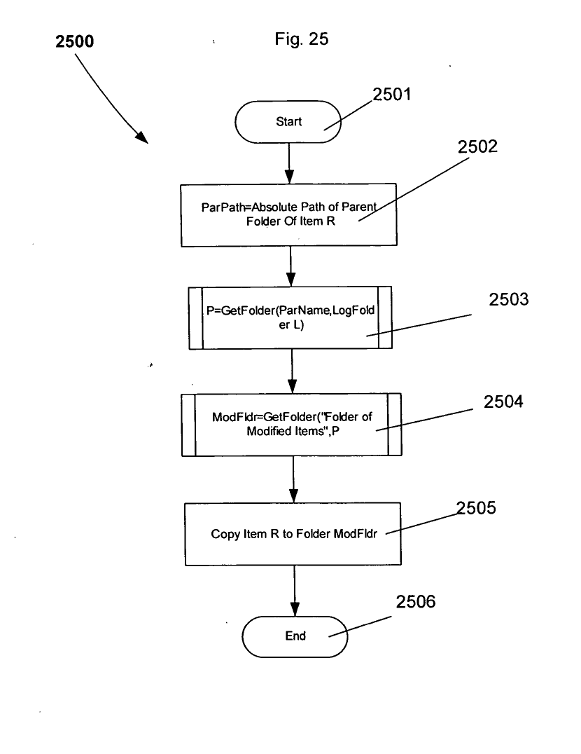

FIG. 25 is a flow chart 2500 of a computer software procedure that gets the path of a parent folder of item R and stores the name of the path of the parent folder in computer memory at step 2502. The procedure begins at step 2501. After step 2502, the procedure of FIG. 25 next calls function GetFolder ( ) at step 2503, passes it the ParName and Log Folder L to get the handle to the parent folder in the Log File and stores it in P. It again calls GetFolder ( ) at step 2504 passing it string “Folder of Modified Items and P to get access to folder where modified items are logged and stores its handle in ModFldr. It then copies the item R to this ModFldr at step 2505. The procedure of FIG. 25 ends at step 2506.

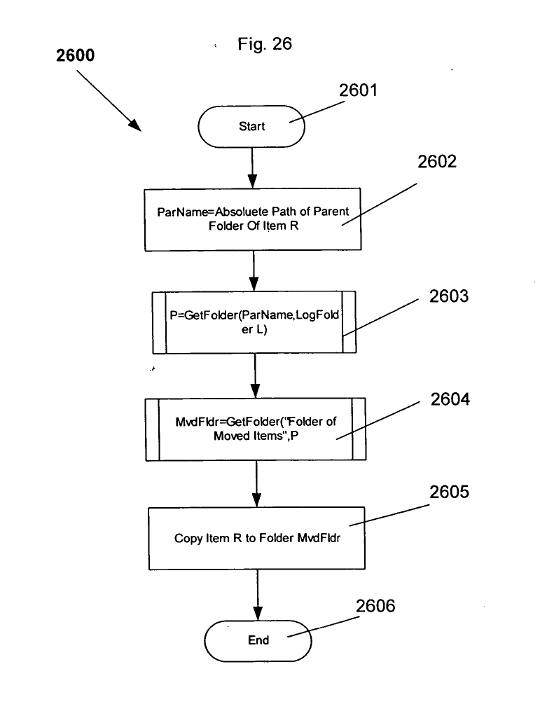

FIG. 26 is a flow chart 2600 of a computer software procedure that calls another computer software function or procedure and passes it various parameters to get the file handle to the parent folder in the Log file. The procedure of FIG. 26 begins at step 2601. The procedure of FIG. 26 gets the path of a parent folder of item R at step 2602 and stores it in ParName. Then at step 2603, the procedure of FIG. 26 calls function GetFolder ( ), passes it the ParName and Log Folder L to get the handle to the parent folder in the Log File and stores it in P. At step 2604, the procedure of FIG. 26, again calls GetFolder ( ) passing it string ” Folder of Moved Items and P to get access to folder where moved items are logged and stores its handle in ModFldr. The procedure of FIG. 26 then copies the item R to this ModFldr at step 2605. The procedure ends at step 2606.

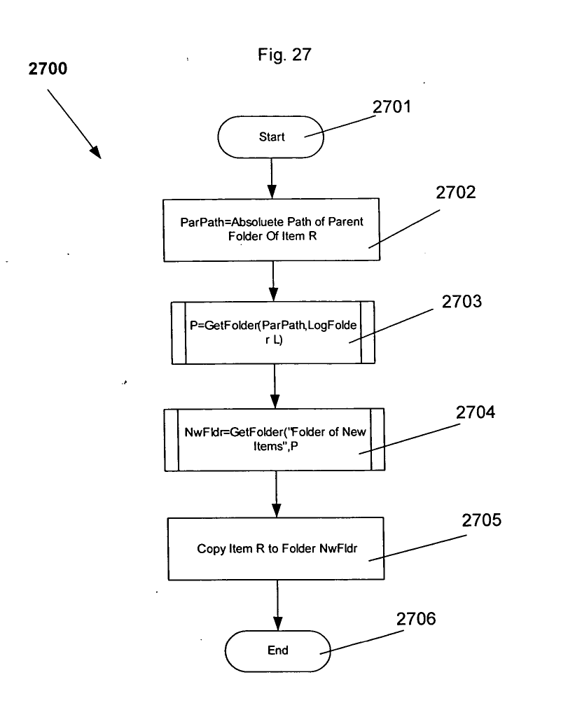

FIG. 27 is a flow chart 2700 of a computer software procedure that gets the path of a parent folder of item R and stores it in computer memory. The procedure of FIG. 27 begins at step 2701. At step 2702 the procedure of FIG. 27 gets the path of parent folder of item R and stores it in ParName. Then the procedure of FIG. 27 calls function GetFolder ( ) at step 2703, passes it the ParName and Log Folder L to get the handle to the parent folder in the Log File and stores it in P. The procedure of FIG. 27 again calls GetFolder ( ) at step 2704 passing it string “Folder of New Items and P to get access to folder where new items are logged and stores its handle in ModFldr. The procedure of FIG. 27 then copies the item R to this ModFldr at step 2705. The procedure is exited at step 2706.

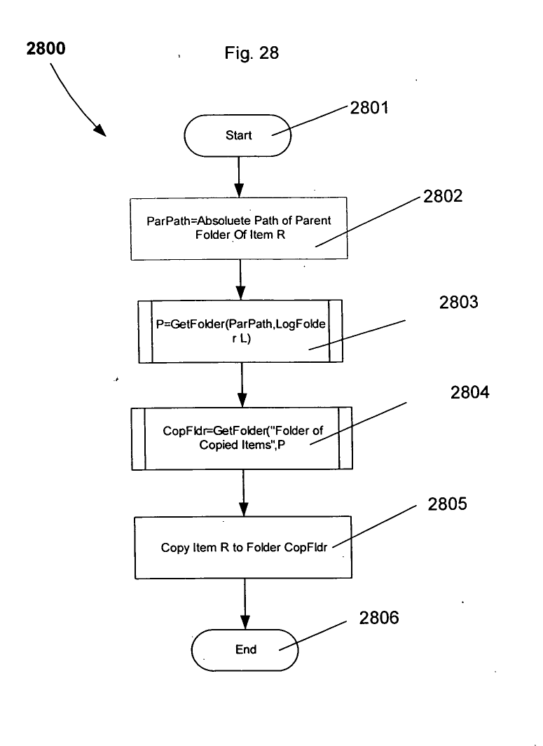

FIG. 28 is a flow chart 2800 of a computer software procedure that gets the path of a parent folder of an item R and stores it in computer memory. The procedure of FIG. 28 begins at step 2801. At step 2802 the procedure gets the path of a parent folder of item R and stores it in ParName. Then the procedure of FIG. 28 calls function GetFolder ( ) at step 2803, passes it the ParName and Log Folder L to get the handle to the parent folder in the Log File and stores it in P. The procedure of FIG. 28 again calls GetFolder ( ) at step 2804 passing it string ” Folder of Copied Items and P to get access to the folder where copied items are logged and stores its handle in ModFldr. The procedure of FIG. 28 then copies the item R to this ModFldr at step 2805. The procedure of FIG. 28 is exited at step 2806.

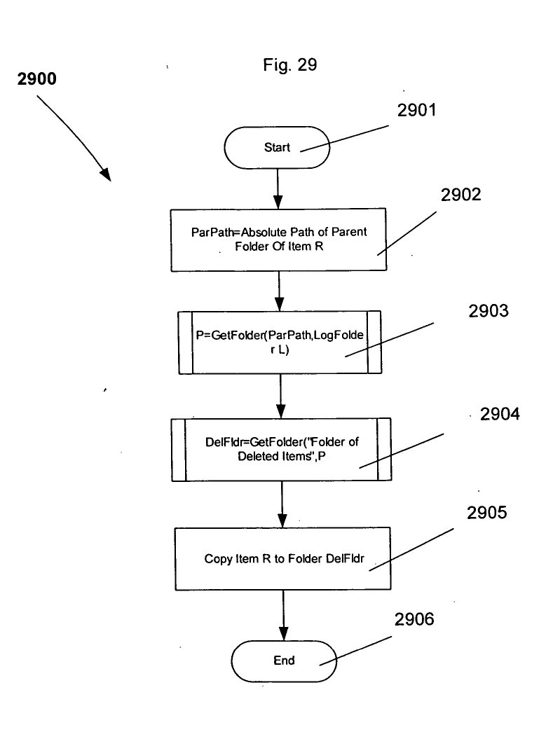

FIG. 29 is a flow chart 2900 of a computer software procedure that gets the path of parent folder of item R and stores it in computer memory. The procedure of FIG. 29 begins at step 2901. The procedure of FIG. 29 gets the path of parent folder of item R at step 2902 and stores it in ParName. Then the procedure calls function GetFolder ( ) at step 2903, passes it the ParName and Log Folder L to get the handle to the parent folder in the Log File and stores it in P. The procedure of FIG. 29 again calls GetFolder ( ) at step 2904 passing it string “Folder of Copied Items and P to get access to folder where copied items are logged and stores its handle in ModFldr. The procedure of FIG. 29 then copies the item R to this ModFldr at step 2905. The procedure of FIG. 29 is exited at step 2906.

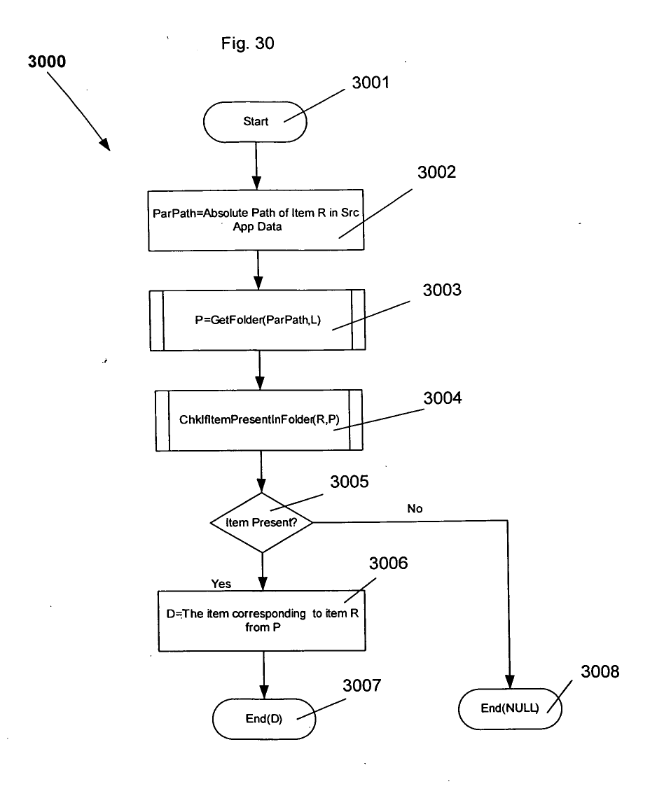

FIG. 30 is a flow chart 3000 of a computer software procedure that calls a function passes it various parameters to get the file handle to the parent folder in the Log File and stores the file handle in a folder P. The procedure of FIG. 30 starts at step 3001. At step 3002, the procedure of FIG. 30 gets the absolute path of parent of item R and stores it in ParPath. Then the procedure of FIG. 30 calls GetFolder ( ) at step 3003 passing it ParPath and Folder L to get access to folder under L and stores its handle in P. Then the procedure of FIG. 30 calls ChkIfItemPresentInFolder ( ) at step 3004, passing it item R and P to check if there is an item in P which matches item R. If such an item is found in step 3005 then the same is retrieved in step 3006 i.e. item D. Then the procedure of FIG. 30 returns the item D through step 3007. If an item not found in step 3005, the procedure of FIG. 30 is exited through step 3008.

A method of one embodiment of the present invention makes the following assumptions. It assumes that application data (source or destination) has the format of a collection of records or folder which in turn contains a collection of records and sub folders. Most of modern application data can be generalized into a format described above. Also, it is assumed that these application data have an API (Application Programmers Interface) to access the records, folders and their properties. Thirdly, it is also assumed that there is a method provided by the providers of the computer application program to trap changes happening in the application data. This trap is referred to as Application Data Monitor 805, shown in FIG. 8A. Application Data Monitor 805 can track and record all the changes happening in the application data in a documented way provided by the application data.

Through a documented method of at least one embodiment of the present invention, the Application Data Monitor 805 of FIG. 8A gets itself attached to the Application Data at system startup and henceforth tracks all the changes happening into Application Data into a monitor repository, Application Data Log Folder 810, inside a Application Data Log File 804. The Application Data Log File 804 file has a similar structure to the particular application data.

At the time of synchronization or backup, Application Data Sync Engine 806 looks if Application Data Log Folder 810 can be found for a given application data or set of application data. If the Application Data Log Folder 810 can not be found, a method to backup and synchronize is used without using the Application Data Monitor 805. Otherwise, each change is observed in source and destination Application Data Log Folder 810, appropriate action is determined and that action is executed for the changed record assuming that local conflict resolution rules have been observed. This application process assumes that only consistent writes are applied.

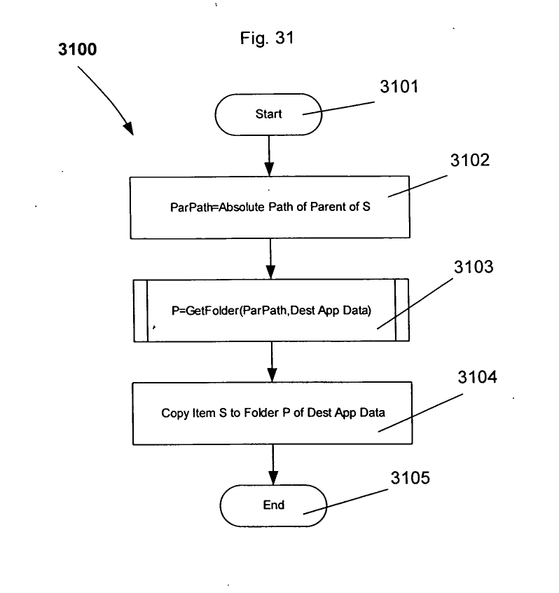

FIG. 31 is a flow chart 3100 of a computer software procedure that given an item R, gets the item R's image item from another Folder L. Further detailed description of the steps of the process.

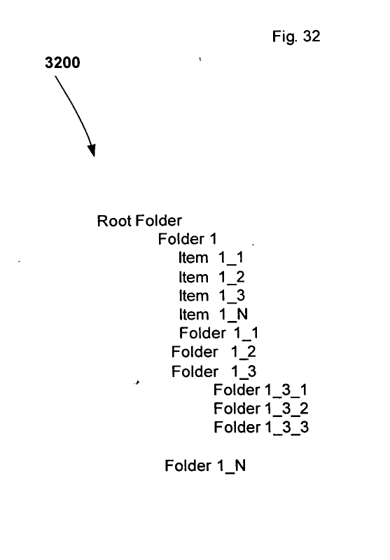

FIG. 32 is a table 3200 that describes the structure of Application Data and is more detailed than FIG. 2. It shows Application Data as a combination of items of folders where a folder in turn contains further sub folders and items.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
an application data monitor implemented by computer software running on a computer;
an application data sync engine implemented by computer software running on a computer;
a front end implemented by computer software running on a computer;
a computer memory;
an application data log file data base including one or more application data log folders stored in the computer memory;
wherein changes to source application data A are monitored by the application data monitor;
wherein changes to source application data A are stored in one or more application data log folders; and
wherein a user can use the front end to select source application data A to be synchronized with image application data A; and
wherein the application data sync engine synchronizes the source application data A with the image application data A by applying the changes made to the source application data A to the image application data A.

2. The apparatus of claim 1 further comprising
a preferences data base stored in the computer memory;
wherein the preferences data base stores setting information required by the application data monitor, front end, and the application data sync engine.

3. The apparatus of claim 1 wherein
changes to source application data A and to source application data B are monitored by the application data monitor.

4. The apparatus of claim 1 wherein
wherein changes to image application data A are monitored by the application data monitor;
wherein changes to image application data A are stored in one or more application data log folders; and
wherein the application data sync engine synchronizes the source application data A with the image application data A by applying the changes made to image application data A to the source application data A.

5. A method comprising the steps of
monitoring changes to source application data A;
storing changes to source application A in one or more application data log folders;
receiving an input from a user to select source application data A to be synchronized with image application data A; and
synchronizing the source application data A with the image application data A by applying the changes made to the source application data A to the image application data A.

6. The method of claim 5 further comprising
storing setting information required for the steps of monitoring, storing, receiving an input, and synchronizing.

7. The method of claim 5 further comprising
monitoring changes to source application data A and to source application data B.

8. The method of claim 5 further comprising
monitoring changes to image application data A;
storing changes to image application data A in one or more application data log folders;
synchronizing the source application data A with the image application data A by applying the changes made to the image application data A to the source application data A.
